(19) United States
(12) Patent Application Publication
(10) Pub. No.: US 2007/0006899 A1
(43) Pub. Date: Jan. 11, 2007

(54) Dishwasher and method of controlling the same

(76) Inventor: Jong Chul Bang, Changwon-si (KR)

Correspondence Address: Song K. Jung;MCKENNA LONG & ALDRIDGE LLP, 1900 K Street, N.W., Washington, DC, 20006, US

(21) Appl. No.: 11/483,768

(22) Filed: Jul. 11, 2006

(30) Foreign Application Priority Data
Jul. 11, 2005 (KR) 10-2005-0062270

(51) Int. Cl. B08B 9/20; B08B 3/00; B08B 7/04; B08B 3/12

(52) U.S. Cl. 134/18; 134/56 D; 134/172; 134/58 D; 134/34; 134/25.2

(57) ABSTRACT

A dishwasher is provided. The dishwasher includes a control unit for controlling an operation of the dishwasher, a washing motor for pumping out washing water reserved in a sump according to a control signal from the control unit, and a fluid passage switching valve providing a flow path for the washing water pumped out by the washing motor. The control unit varies an RPM of the washing motor when the flow path for the washing water is changed by the fluid passage switching valve.

### BACKGROUND OF THE INVENTION

1. Field of the Invention

The present invention relates to a dishwasher, and more particularly, to a dishwasher that can reduce noise generated during a washing cycle and a method of controlling the dishwasher.

2. Description of the Related Art

A dishwasher is a machine for washing dishes received in a rack using washing water sprayed under high pressure.

The dishwasher includes a tube defining a washing chamber and a sump mounted on a bottom of the tub to reserve the washing water. A detergent dispenser for dispensing the detergent by a fixed quantity is formed on an inner surface of a door. A predetermined amount of the detergent is supplied into the detergent dispenser.

By the pumping operation of a washing pump mounted in the sump, the washing water is directed toward the spraying nozzle and sprayed through a plurality of spraying holes formed on an extreme end of the spraying nozzle.

Food waste adhered to the dishes are removed from the dishes by the washing water sprayed under the high pressure and the removed food waste is collected on the floor of the tub.

In addition, the dishwasher further includes a lower nozzle installed on a top of the sump to spray the washing water upward, an upper nozzle disposed on a inner-central portion of the tub, and a top nozzle located near a ceiling of the tub 11 to spray the washing water downward.

The washing water collected in the sump is alternatively directed to the lower and upper nozzles. To realize this, a fluid passage switching valve is used.

The fluid passage switching valve is disposed on a path along which the washing water is directed to the lower or upper nozzle. The fluid passage switching valve rotates a motor to form a washing water flowing path.

However, when the fluid passage switching valve rotates to form the washing water flowing path, the washing water may momentarily flow toward both the upper and lower nozzles.

In this case, the water level of the sump is quickly lowered and thus an impeller for pumping out the washing pump is exposed to the air. When the impeller is exposed to the air, the noise generated by the impeller increases suddenly.

### SUMMARY OF THE INVENTION

Accordingly, the present invention is directed to a dishwasher and a method of controlling the same that substantially obviate one or more problems due to limitations and disadvantages of the related art.

An object of the present invention is to provide a dishwasher that can reduce the noise that may be generated during the rotation of the fluid passage switching valve and a method of controlling the dishwasher.

To achieve these objects and other advantages and in accordance with the purpose of the invention, as embodied and broadly described herein, there is provided a dishwasher including: a control unit for controlling an operation of the dishwasher; a washing motor for pumping out washing water reserved in a sump according to a control signal from the control unit; and a fluid passage switching valve providing a flow path for the washing water pumped out by the washing motor, wherein the control unit varies an RPM of the washing motor when the flow path for the washing water is changed by the fluid passage switching valve.

In another aspect of the present invention, there is provided a method of controlling a dishwasher, the method including: performing a washing cycle by pumping washing water out of a sump; detecting if a washing water flow path changes according to the rotation of a fluid passage switching valve provided on a side of the sump; and changing an RPM of the washing motor when the fluid passage switching valve starts rotating.

According to the present invention, since the washing motor operates at a relatively lower RPM when the flow path changes by the rotation of the fluid passage switching valve, the noise can be reduced even when the impeller is exposed to the air.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a dishwasher according to an embodiment of the present invention;

FIG. 2 is a perspective view of a sump of the dishwasher of FIG. 1;

FIG. 3 is an exploded perspective view of a sump of the dishwasher of FIG. 2;

FIGS. 4 through 6 are views illustrating flow of washing water by the rotation of a fluid passage switching valve of FIG. 3;

FIG. 7 is a block diagram of the dishwasher of FIG. 2;

FIG. 8 is a graph illustrating a driving RPM control of a washing motor; and

FIG. 9 is a flowchart of a method of controlling a dishwasher according to an embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

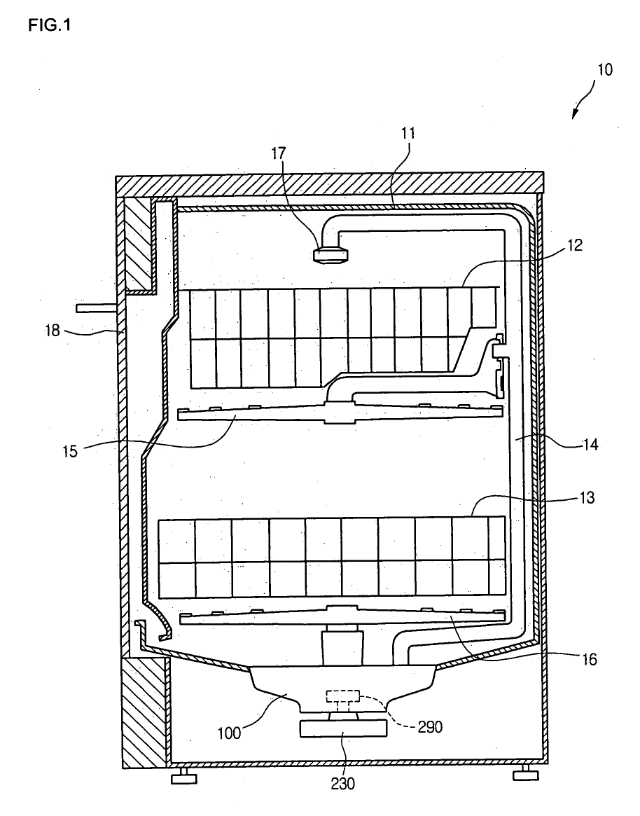

FIG. 1 is a sectional view of a dishwasher according to an embodiment of the present invention.

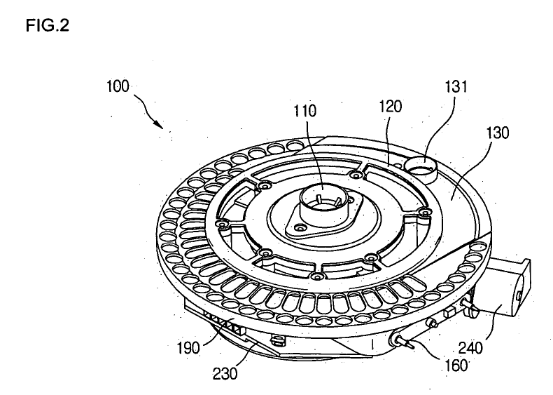

Referring to FIG. 2, a dishwasher 10 includes a tub 11 defining a washing chamber, a door 18 provided on a front portion of the tub 11 to open and close the washing chamber, and a sump 100 mounted on a bottom-center of the tub 11 and reserving washing water therein.

The dishwasher 10 further includes a washing motor 230 for driving a washing pump 290 mounted in the sump 100, a water guide 14 defining a path along which washing water pumped out by the washing pump flows, a lower nozzle 16 coupled to a top of the sump 100 to spray the washing water upward and/or downward in the washing chamber, an upper nozzle 15 extending from a portion of the water guide 14 toward a center of the tub 11, and a top nozzle 17 extending from a top of the water guide 14 and located near a ceiling of the tub 11 to spray the washing water downward.

The washing water reserved in the sump 100 is pumped out by the washing pump 290 and directed to the lower nozzle 16 or the water guide 14 according to the rotation of the fluid passage switching valve that will be described later.

The dishwasher 10 further includes an upper rack 12 placed right above the upper nozzle 15 and a lower rack 13 disposed right above the lower nozzle 16. That is, the dishes received on the upper rack 12 are washed by the washing water sprayed from the upper and top nozzles 15 and 17. The dishes received on the lower rack 13 are washed by the washing water sprayed from the lower nozzle 16.

The operation of the dishwasher 10 will now be described.

The door 18 is first opened and the upper rack 12 and/or lower rack 13 are withdrawn out of the dishwasher 10.

The dishes are arranged on the racks 12 and 13. Then, the racks 12 and 13 are returned to their initial locations and the door 18 is closed. The power is turned on to wash the dishes received in the racks 12 and 13.

Meanwhile, when the power is turned on, the washing water is supplied from a water source (not shown) into the sump 100. After a predetermined amount of the washing water is supplied into the sump 100, the washing motor 230 operates. At this point, an impeller (not shown) connected to a motor shaft of the washing motor 230 and disposed in the washing pump 290 rotates to pump out the washing water and direct the pumped washing water to the lower nozzle 16 or the water guide 14.

Meanwhile, when the impeller rotates in a state where it is exposed to the air, the noise generated by the impeller increases. Therefore, the present invention provides means for reducing the noise.

The washing water directed to the water guide 14 is sprayed into the washing chamber via the top and upper nozzles 17 and 15. The washing water sprayed from the top and upper nozzles 17 and 15 washes the dishes arranged in the racks 12 and 13.

The washing water sprayed upward from the lower nozzle 16 washes the dishes arranged in the lower rack 13.

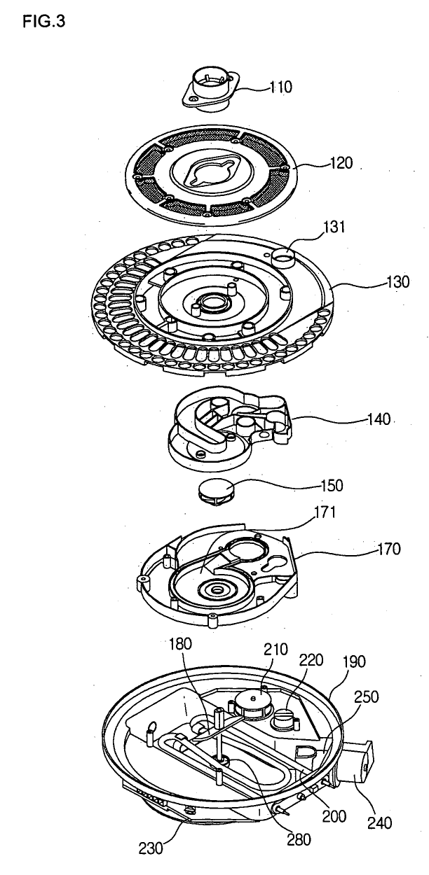

FIG. 2 is a perspective view of a sump of the dishwasher of FIG. 1 and FIG. 3 is an exploded perspective view of a sump of the dishwasher of FIG. 2.

Referring to FIGS. 2 and 3, the sump 100 includes a sump case 190 for reserving the washing water, a sump cover 130 for covering an opening of the sump case 190, a self-cleaning filter assembly 120 disposed on a top portion of the sump cover 130 and elevated by a predetermined height, and a lower nozzle holder 110 disposed on the central portion of the self-cleaning filter assembly 120 and connected to the lower nozzle 16.

The sump 100 further includes a washing motor 230 mounted on a lower portion of the sump case 190 to generate rotational force, and a drain pump 250 and a drain motor 240 that are mounted on a side portion of the sump case 190 to drain the washing water to an external side.

In addition, the sump 100 further includes a heater 200 mounted on an inner bottom of the sump case 190 to heat the washing water, a disposer 180 rotating together with a motor shaft 231 to grind food wastes, a pump lower 170 forming a soil chamber in which the food wastes are accumulated, a fluid passage guide 140 disposed between the sump cover 130 and the pump lower 170, and a washing pump disposed between the pump lower 170 and the fluid passage guide 140 to pump out the washing water.

The washing pump is disposed I in the sump case 190 and is operated by the washing motor 230. By the operation of the washing pump, an impeller 150 rotated coupled to a driving shaft of the washing pump.

As the impeller 150 rotates, the washing water reserved in the sump case 190 rotates in the pump case 171.

The fluid passage guide 140 is provided at a top surface with a passage for guiding the washing water pumped by the washing pump 290 to the upper nozzle or the lower nozzle.

The sump 100 includes a fluid passage switching valve 210 for directing the washing water pumped out by the washing pump to the water guide or the lower nozzle side and a turbidity sensor 220 mounted near the fluid passage switching valve 210.

A rotational motor for rotating the fluid passage switching valve 210 is further provided to change the washing water flowing path by rotating the fluid passage switching valve 210.

That is, the washing water pumped out flows to the passage guide 140 according to the rotation of the fluid passage switching valve 210 and is then directed to the nozzle holder 110 or the water guide holder 131 along the fluid passage formed on the passage guide 140.

The operation of the sump 100 will now described with reference to the flow of the washing water.

First, when the washing cycle starts, the washing water is supplied form a water source into the sump case 190 and the impeller 150 rotates by the washing motor 230.

When the impeller 150 rotates, the washing water 171 flows into the pump case 171 and is then directed to the fluid passage switching valve 210.

Then, the washing water directed to the fluid passage switching valve 210 flows to the water guide 14 or the lower nozzle holder 110 along the fluid passage formed on the passage guide 140.

Then, the washing water directed to the water guide 14 or the lower nozzle holder 110 is sprayed into the tub 11 through the upper nozzle 15 or the lower nozzle 16.

The operation of the fluid passage switching valve 210 will now be described.

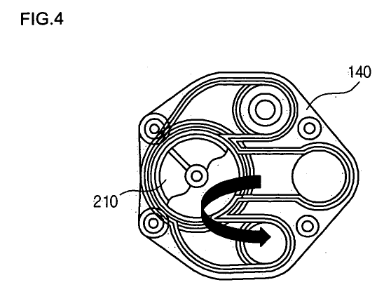

FIGS. 4 through 6 are views illustrating flow of washing water by the rotation of a fluid passage switching valve of FIG. 3.

The washing water directed to the passage guide 140 by the operation of the washing pump or washing motor is drawn out through an opening formed by the rotation of the fluid passage switching valve 210.

The rotational motor for rotating the fluid passage switching valve 210 is connected to the fluid passage switching valve 210 by a motor shaft to rotate the fluid passage switching valve 210 clockwise or counterclockwise, thereby switching the washing water flowing path.

Referring first to FIG. 4 there is shown a case where the washing water flows to the lower nozzle holder 110 or the lower nozzle 16.

The washing water pumped out by the rotation of the impeller 150 is directed to the passage guide 140 and is then drawn out through an opening formed by the rotation of the fluid passage switching valve 210. The flowing direction of the washing water is indicated by arrow in FIG. 4. The washing water flowing in the direction indicated by the arrow is directed to the lower nozzle holder 110.

In this case, the dishes are washed by the washing water sprayed from the lower nozzle 16.

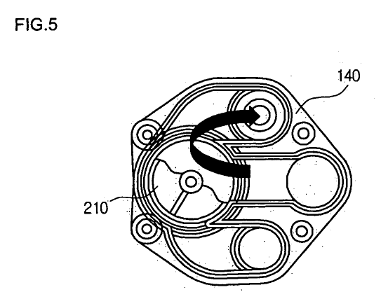

Referring first to FIG. 5, there is shown a case where the washing water flows to the water guide 14 or the upper nozzle 15.

When the fluid passage is formed as shown in FIG. 5 as the fluid passage switching valve 210 rotates by the rotational motor, the washing water directed into the passage guide 140 is directed toward the water guide 14 while flowing in a direction indicated by arrow of FIG. 5.

That is, as indicated by the arrow, the washing water flows to the water guide holder 131 formed on the sump case 130 and is then directed to the upper nozzle 15 and the top nozzle 17 along the water guide 14 coupled to the water guide holder 131.

In this case, the dishes are washed by the washing water sprayed from the upper nozzle 15.

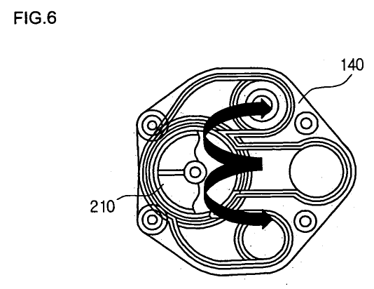

FIG. 6 illustrates a fluid passage that can be formed while the fluid passage switching valve 210 rotates. By the fluid passage formed as shown in FIG. 6, the washing water directed to the passage guide 140 may flow to both the lower nozzle 16 and the water guide 14.

In this case, since two washing water flowing paths are formed, a flow rate of the washing water increases suddenly to lower the water level of the sump case 190.

As the water level of the sump case 190 is suddenly lowered, the impeller 150 for pumping out the washing water is exposed to the air to increase the noise generated by the impeller.

In order to reduce the noise, the driving RPM of the washing motor 230 is reduced during the rotation of the fluid passage switching valve 210, thereby reducing the RPM of the impeller.

A method for controlling the driving RPM of the washing motor during the rotation of the fluid passage switching valve 2100 will now be described in more detail.

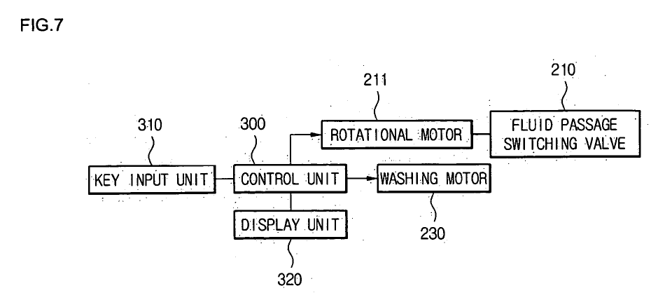

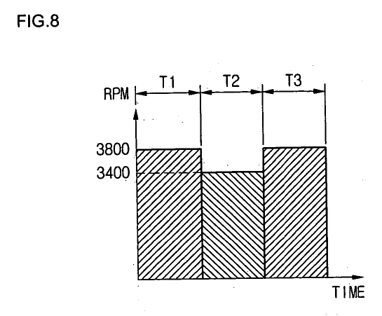

FIG. 7 is a block diagram of the dishwasher of FIG. 2 and FIG. 8 is a graph illustrating a driving RPM control of a washing motor.

The dishwasher includes a key input unit 310 for selecting a washing mode, a control unit 300 for operating the dishwasher in response to the mode selected through the key input unit 310, and a display unit 320 displaying a current operation state of the dishwasher.

The dishwasher further includes a rotational motor 211 for rotating the fluid passage switching valve 210 in response to the control of the control unit 300 and a washing motor 230 for pumping out the washing water reserved in the sump 100.

Since the washing water is sprayed through the upper or lower nozzle 16 or 15 according to the fluid passage formed by the rotation of the fluid passage switching valve 210. That is, the dishes are washed by the washing water sprayed from the upper nozzle 16 or the lower nozzle 15 according to the fluid passage formed by the rotation of the fluid passage switching valve 210.

The control unit 300 controls the operation of the rotational motor 211 to selectively rotate the fluid passage switching valve 210.

Particularly, when the rotational motor 230 operates, the control unit 300 controls the washing motor 230 such that the washing motor 230 operates at a different RPM. That is, as shown in an RPM graph of FIG. 8, in a time period T2, the RPM of the washing motor is lower than the normal RPM.

That is, in time periods T1 and T3 where the rotational motor 211 is not operated, the washing motor 230 operates at the normal RPM, and, in time period T2 where the rotational motor 211 operates, the washing motor 230 operates at an RPM lower than the normal RPM.

When the fluid passage switching valve 210 rotates or the rotational motor 211 operates, the washing motor 230, which has operated at a first RPM 1RPM, intermittently operates at a second RPM 2RPM lower than the first RPM 1RPM.

In FIG. 8, a case where the RPMs in time periods T1 and T3 are 3800 and the RPM in time period T2 is 3400 is exampled. However, the present invention is not limited to this case.

The control unit 300 detects if the impeller 150 is exposed to the air by detecting if the fluid passage switching valve 210 rotates or if the rotational motor 211 operates.

When the rotational motor rotational motor 211 operates to change the washing water flow passage during an automatic washing mode set by the user, the control unit 300 displays a message or generates a sound that lets the user know that the RPM of the washing motor 230 is reduced.

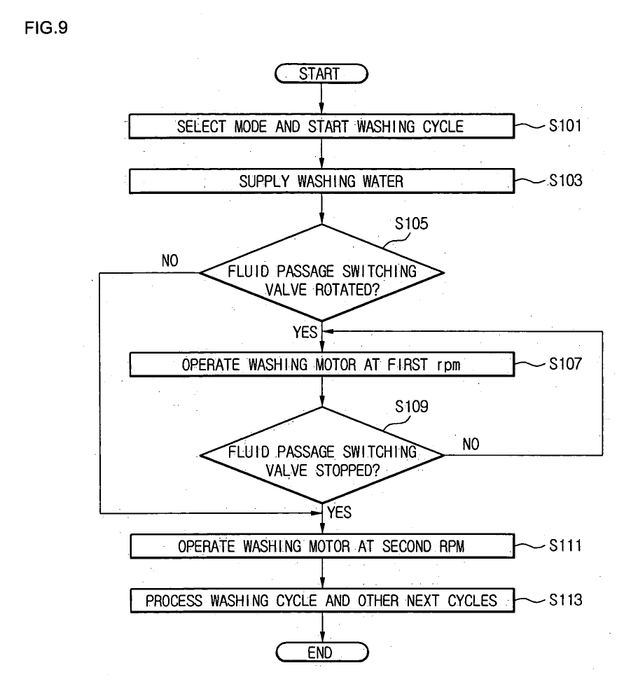

FIG. 9 is a flowchart of a method of controlling a dishwasher according to an embodiment of the present invention.

A washing mode is selected through the key input unit 310 and the operation power is inputted (S101).

The washing water is reserved in the sump 100 (S103) and the reserved washing water is pumped out to perform the washing cycle for washing the dishes.

During the washing cycle, it is a need to change a washing water spraying location from the upper nozzle to the lower nozzle or from the lower nozzle to the upper nozzle, it is determined if the washing water spraying location is changed by detecting if the fluid passage switching valve 210 rotates (S105)

When it is determined that the fluid passage switching valve 210 is not rotated, i.e., the rotational motor 211 is not operated, the washing motor operates at the second RPM 2 RPM (S111).

When it is determined that the fluid passage switching valve 210 is rotated, i.e., the rotation motor 211 is operated, the washing motor 230 operates at the first RPM 1RPM lower than the second RPM 2RPM (S107).

Then, when the rotation of the fluid passage switching valve 210 is stopped, i.e., the operation of the rotational motor 211 is stopped, the washing motor 230 operates again at the second RPM 2RPM (S11).

Next, the RPM of the washing motor 230 is controlled according to whether the fluid passage switching valve 210 rotates and the washing cycle and other next cycles are processed (S113).

By controlling the RPM of the washing motor according to the rotation of the fluid passage switching valve 210 or the operation of the rotational motor 211, the noise of the impeller can be reduced even when two fluid passages are temporarily formed by the rotation of the fluid passage switching valve 210 as shown in FIG. 6.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher comprising;
a control unit for controlling an operation of the dishwasher;
a washing motor for pumping out washing water reserved in a sump according to a control signal from the control unit; and
a fluid passage switching valve providing a flow path for the washing water pumped out by the washing motor,
wherein the control unit varies an RPM of the washing motor when the flow path for the washing water is changed by the fluid passage switching valve.

2. The dishwasher according to claim 1, further comprising a rotational motor for rotating the fluid passage switching valve, wherein the control unit varies the RPM of the washing motor while rotating the rotational motor.

3. The dishwasher according to claim 1, wherein when the flow path for the washing water changes by the rotation of the fluid passage switching valve during the washing motor operates at a first RPM, the control unit changes an RPM of the washing motor to a second RPM lower than the first RPM.

4. A dishwasher comprising:
a lower nozzle for spraying washing water according to an operation of a washing motor;
an upper nozzle formed above the lower nozzle;
a fluid passage switching valve providing a flow path for directing the washing water pumped by the washing motor to the lower nozzle or the upper nozzle; and
a control unit for controlling an operation of the washing motor and the fluid passage switching valve,
wherein, when the flow path changes by the rotation of the fluid passage switching valve, the control unit reduces an RPM of the washing motor.

5. The dishwasher according to claim 4, wherein a washing cycle is preformed by spraying the washing water through one of the upper and lower nozzles according to the rotation of the fluid passage switching valve and, when the fluid passage switching valve rotates to change the flow path, the control unit reduces the RPM of the washing motor.

6. The dishwasher according to claim 4, further comprising a rotational motor connected to the fluid passage switching valve by a driving shaft and the control unit reduces the RPM of the washing motor when the rotation motor operates.

7. A dishwasher comprising:
a washing motor operating according to a control signal of a control unit to control an operation of the dishwasher;
a washing pump for pumping out washing water reserved in a sump according to an operation of the washing motor;
an impeller formed in the washing pump and connected to a driving shaft of the washing motor;
a fluid passage switching valve for changing a flow path for the washing water pumped out by the rotation of the impeller; and
a rotational motor for rotating the fluid passage switching valve,
wherein the control unit detects whether the impeller is exposed to the air by detecting if the fluid passage switching valve rotates.

8. The dishwasher according to claim 7, wherein the control unit varies an RPM of the washing motor when the rotational motor operates.

9. The dishwasher according to claim 8, wherein, when the fluid passage switching valve rotates while the washing motor operates at a first RPM, the washing motor intermittently operates at a second RPM.

10. A method of controlling a dishwasher for washing dishes using washing water sprayed from one of upper and lower nozzles, the method comprising:
starting a washing cycle for washing dishes; and
reducing an RPM of the washing motor when a washing water spraying location is changed from the upper nozzle to the lower nozzle or from the lower nozzle to the upper nozzle.

11. The method according to claim 10, wherein the water spraying location change is finished, the RPM of the washing water increases.

12. A method of controlling a dishwasher, the method comprising:
performing a washing cycle by pumping washing water out of a sump;
detecting if a washing water flow path changes according to the rotation of a fluid passage switching valve provided on a side of the sump; and
changing an RPM of the washing motor when the fluid passage switching valve starts rotating.

13. The method according to claim 12, wherein the rotation of the fluid passage switching valve is preformed by the operation of a rotational motor having a driving shaft connected to the fluid passage switching valve and the rotation of the fluid passage switching valve is detected by detecting if the rotational motor operates.

14. The method according to claim 12, wherein, when the fluid passage switching valve rotates, the washing motor, which has operated at a first RPM, operates at a second RPM lower than the first RPM.

15. The method according to claim 14, wherein when the rotation of the fluid passage switching valve is finished, the RPM of the washing motor is returned to the first RPM.
